(19) United States
(12) Patent Application Publication
(10) Pub. No.: US 2017/0185294 A1
(43) Pub. Date: Jun. 29, 2017

(54) MEMORY SYSTEM AND OPERATING METHOD THEREOF

(71) Applicant: SK hynix Inc., Gyeonggi-do (KR)

(72) Inventors: Young-Suk MOON, Gyeonggi-do (KR); Hong-Sik KIM, Gyeonggi-do (KR)

(21) Appl. No.: 15/146,523

(22) Filed: May 4, 2016

(30) Foreign Application Priority Data
Dec. 23, 2015 (KR) 10-2015-0184913

(51) Int. Cl. G06F 3/06; G06F 12/10

(52) U.S. Cl. CPC G06F 3/061; G06F 3/0626; G06F 3/0656; G06F 3/0658; G06F 3/0659; G06F 3/0665; G06F 3/0673; G06F 12/10; G06F 2212/1016; G06F 2212/1056; G06F 2212/152

(57) ABSTRACT

A memory system may include a memory device including N (N is an integer of 1 or more) physical banks and a memory controller suitable for communicating with a host using M (M is an integer greater than N) logical banks and for communicating with the memory device. The memory controller may include M row buffers corresponding to the respective M logical banks, for caching the data of the respective M logical banks and an address translator for performing an address translation between a logical address used for communication with the host and a physical addresses used for communication with the memory device.

### CROSS-REFERENCE TO RELATED APPLICATION(S)

The present application claims priority of Korean Patent Application No, 10-2015-0184913 filed on Dec. 23, 2015, which is incorporated herein by reference in its entirety.

### BACKGROUND

1. Field

Exemplary embodiments of the present invention relate generally to a memory system including a memory device and a memory controller, and an operating method thereof.

2. Description of the Related Art

The number of banks in a memory device is important because only one row of each bank can be activated at any one time during operation of the memory device. Hence, for example, if a memory device includes 8 banks, only a maximum of 8 rows in the memory device may be activated one for each bank, at one time. Likewise, if a memory device includes 4 banks, only a maximum of 4 rows can be activated at one time.

Hence, for enhancing the performance of a memory device, the number of banks can be increased, however, at a substantial increased cost. Generally, a memory device for graphics, such as, for example, a GDDR5 SDRAM has better parallelism than known memory devices such as, for example, a DDR3 SDRAM, because it has more banks, however, it is more expensive.

### SUMMARY

Various embodiments are directed to the provision of a simpler more cost efficient technology for improving performance of a memory system.

In an embodiment, a memory system may include a memory device including N (N is an integer of 1 or more) physical banks and a memory controller suitable for communicating with a host using M (M is an integer greater than N) logical banks and for communicating with the memory device. The memory controller may include M row buffers corresponding to the respective M logical banks, for caching the data of the respective M logical banks and an address translator for performing an address translation between a logical address used for communication with the host and a physical addresses used for communication with the memory device.

The logical address may include a logical bank address, a logical row address, and a logical column address, and the physical address may include a physical bank address, a physical row address, and a physical column address.

The address translator may translate one or more bits of the logical bank address into the physical bank address, may translate the remaining bits of the logical bank address and the logical row address into the physical row address, and may translate the logical column address into the physical column address.

Each of the M row buffers may store cached data, validity information regarding validity of the row buffer, the logical row address of the cached data, the physical bank address of the cached data, the physical row address of the cached data, and dirty/clean information indicating dirty or clean for the cached data.

Each of the M row buffers stores: cached data divided into two or more portions; validity information regarding validity of the row buffer; a logical row address of the cached data; a physical bank address of the cached data; a physical row address of the cached data; data validity information regarding validity for each of the two or more portions of the cached data; and dirty/clean information indicating dirty or clean for each of the two or more portions of the cached data.

If the data of a logical bank address and logical row address to be read by the host has been cached in the row buffer of a corresponding logical bank of the M row buffers, the memory controller may read the data from the row buffer of the corresponding logical bank and send the read data to the host. If the data of a logical bank address and logical row address to be read by the host has not been cached in the row buffer of a corresponding logical bank of the M row buffers, the memory controller may read data from the memory device using a physical bank address and physical row address converted from the logical bank address and logical row address to be read by the host and transfer the read data to the host.

When the host instructs a write operation, the memory controller may access the row buffer among the M row buffers and updates the accessed row buffer with write data. The accessed row buffer may be a row buffer of a logical bank for which the write operation has been instructed.

The memory device may be updated with the write data with which the row buffer of the logical bank for which the write operation has been instructed has been updated, if a row cached in the row buffer of the logical bank for which the write operation has been instructed is changed.

The memory controller further may include a host interface suitable for communication with the host, a scheduler suitable for determining the sequence of the operations of the memory device, a command generator suitable for generating commands to be applied to the memory device, and a memory interface suitable for communication with the memory device.

The host may activate one row at a time for each logical bank.

In an embodiment, an operating method of a memory controller may include: receiving a read request for a specific logical row of the K-th logical bank of M logical banks from a host; determining whether the row buffer of the K-th logical bank is empty; if it is determined that the row buffer of the K-th logical bank is empty, reading data from a certain physical row of a certain physical bank among N physical banks included in a memory device and transferring the read data to the host, wherein the certain physical bank is corresponding to the K-th logical bank, and the certain physical row is corresponding to the specific logical row; and updating the row buffer of the K-th logical bank with the read data from the memory device. The N may be an integer of 1 or more, the M may be an integer greater than N, and the K may be an integer of 1 or more to M or less.

The operating method of the memory controller may further include determining whether there is a row hit for the K-th row buffer, if it is determined that that the row buffer of the K-th logical bank is not empty.

The operating method of the memory controller may further include transferring data stored in the K-th row buffer to the host if it is determined that there is the row hit for the K-th row buffer.

The operating method of the memory controller may further include: updating a region of the memory device corresponding to a physical bank address and a physical row address with dirty data stored in the K-th row buffer if it is determined that there is no the row hit for the K-th row buffer; reading the data from the physical row corresponding to the specific logical row of the physical bank which belongs to the N physical banks of the memory device and which corresponds to the K-th logical bank and transferring the read data to the host; and updating the row buffer of the K-th logical bank with the data read from the memory device.

In an embodiment, an operating method of a memory controller may include: receiving a write request for a specific logical row of the K-th logical bank of M logical banks from a host determining whether there is a row hit for the row buffer of the K-th logical bank; if it is determined that there is the row hit, updating the row buffer of the K-th logical bank with write data; if it is determined that there is no the row hit, updating a physical row, corresponding to the specific logical row of a physical bank which belongs to N physical banks of a memory device and which corresponds to the K-th logical bank, with dirty data of the row buffer of the K-th logical bank; and updating the row buffer of the K-th logical bank with the write data. The N may be an integer of 1 or more, the M may be an integer greater than N, and the K may be an integer of 1 or more to M or less.

### BRIEF DESCRIPTION OF THE DRAWINGS

FIG. 1 is a diagram illustrating a memory system, according to an embodiment of the present invention.

FIG. 2 is a diagram illustrating the operation of an address translator, according to an embodiment of the present invention.

FIG. 3 is a diagram illustrating a relationship between physical banks and logical banks.

FIG. 4 is a diagram illustrating an example of information stored in each of a plurality of row buffers, according to an embodiment of the present invention.

FIG. 5 is a diagram illustrating another example of information stored in each of a plurality of row buffers, according to an embodiment of the present invention.

FIGS. 6 to 10 are diagrams illustrating how information stored in the row buffers may be changed when a read operation and a write operation are performed in a memory system, according to an embodiment of the present invention.

FIG. 11 is a flowchart of a read operation of a memory system, according to an embodiment of the present invention.

FIG. 12 is a flowchart of a write operation of a memory system, according to an embodiment of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

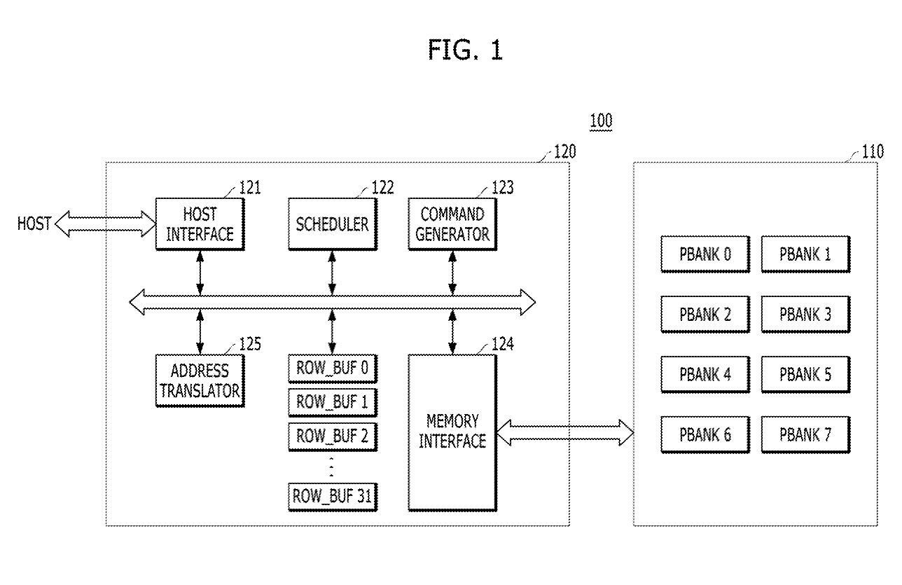

FIG. 1 illustrates a memory system 100, according to an embodiment of the present invention.

According to the embodiment of FIG. 1, the memory system 100 may include a memory device 110 and memory controller 120.

The memory device 110 may include eight (8) physical banks PBANK0˜PBANK7. However, we note, that the number of physical banks may be changed by design. The memory device 110 may receive commands and physical addresses from the memory controller 120 and send and receive data to and from the memory controller 120. When a read operation is performed, data may be transmitted from the memory device 110 to the memory controller 120. When a write operation is performed, data may be transmitted from the memory controller 120 to the memory device 110.

The memory controller 120 may control the memory device 110 in response to a request from a host. HOST. Communication between the host HOST and the memory controller 120 may be performed on the assumption that the memory device 110 includes thirty two (32) logical banks. That is, logical addresses transmitted from the host HOST to the memory controller 120 may be configured based on the 32 logical banks. The number of logical banks may, also be changed by design. Communication between the memory controller 120 and the memory device 110 may be performed on the assumption that the memory device 110 includes 8 physical banks. That is, physical addresses transmitted from the memory controller 120 to the memory device 110 may be configured based on the 8 physical banks.

The memory controller 120 may include a host interface 121, a scheduler 122, a command generator 123, a memory interface 124, an address translator 125, and a plurality of row buffers, for example, ROW_BUF0˜ROW_BUF31 having the same number as the number of logical banks. Hence, in the embodiment of FIG. 1, the controller includes 32 row buffers ROW_BUF0˜ROW_BUF31.

The host interface 121 may be any suitable interface between the memory controller 120 and the host HOST. A request of the host HOST may be received from the host HOST through the host interface 121. The results of processing corresponding to a request of the host HOST may be transmitted to the host HOST through the host interface 121.

The scheduler 122 may determine the sequence of the requests that belong to requests from the host HOST and that will be made to the memory device 110. The scheduler 122 may change the sequence of the requests received from the host HOST and the sequence of the operations to be instructed for the memory device 110 for improving performance of the memory device 110. For example, although the host HOST may first request a read operation of the memory device 110 and then request a write operation of the memory device 110, the scheduler 122 may control the sequence so that the write operation may be performed prior to the read operation. The scheduler 122 may access row buffers ROW_BUF0˜ROW_BUF31 and perform an operation for determining whether or not to perform a read/write operation on the row buffers ROW_BUF0˜ROW_BUF31 or whether or to perform a read/write operation on the memory device 110.

The command generator 123 may generate a command to be applied to the memory device 110 according to an operating sequence determined by the scheduler 122.

The memory interface 124 may be any suitable interface for an interface between the memory controller 120 and the memory device 110. Commands and physical addresses may be transmitted from the memory controller 120 to the memory device 110 through the memory interface 124. Data may be transmitted and received between the memory device 110 and the memory controller 120 through the memory interface 124. The memory interface 124 is also referred to hereinafter as a PHY interface.

The address translator 125 may perform a translation operation between logical addresses used for communication with the host HOST and physical addresses used for communication with the memory device 110.

The row buffers ROW_BUF0˜ROW_BUF31 correspond to 32 logical banks, respectively, and cache the data of their respective logical banks. When a read or write request is made from the host HOST, the memory controller 120 may operate as if the memory device 110 has the physical banks PBANK0˜PBANK7 larger than 32 banks by first accessing the row buffers ROW_BUF0˜ROW_BUF31 and then reading data from the row buffers ROW_BUF0˜ROW_BUF31 or writing data in the row buffers ROW_BUF0˜ROW_BUF31 as much as possible. That is, the memory device 110 includes only the 8 physical banks PBANK0˜PBANK7, but the memory system 100 may provide the host HOST with enhanced performance, as if the memory device 110 had 32 banks.

In FIG. 1, the memory device 110 has been illustrated as including the 8 physical banks PBANK0˜PBANK7, but the memory device 110 may include any specific number N of physical banks equal to or larger than 1, wherein is a natural number. Furthermore, in FIG. 1, the memory controller 110 has been illustrated as supporting the 32 logical banks, but the number of logical banks may be a specific number M greater than the number of physical banks of the memory device 110, wherein M is a physical number.

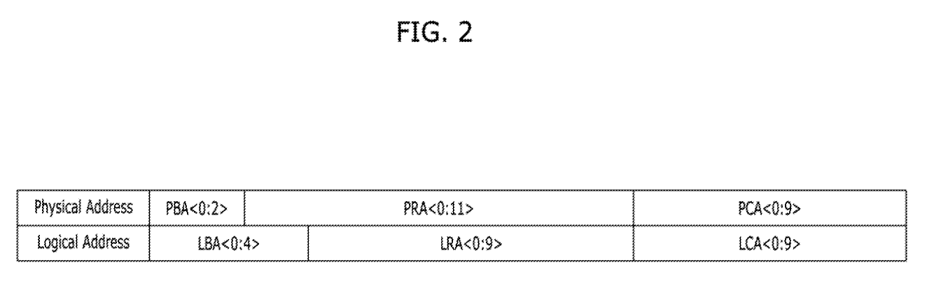

FIG. 2 is a diagram illustrating the operation of an address translator, according to an embodiment of the present invention. For example, the operation of FIG. 2 may be the operation of the address translator 125 of FIG. 1.

According to the embodiment of FIG. 2, a physical address may include a physical bank address PBA<0:2> of 3 bits, a physical row address PRA<0:11> of 12 bits, and a physical column address PCA<0:9> of 10 bits. Furthermore, a logical address may include a logical bank address LBA<0:4> of 5 bits, a logical row address LRA<0:9> of 10 bits, and a logical column address LCA<0:9> of 10 bits.

A translation between the physical address and the logical address may be performed by translating 2 bits PRA<10:11> (i.e. the most significant bits) of the physical row address PRA<0:11>, into the least significant bits LBA<0:1> of the physical bank address LBA<0:4> of the logical address. In this case, the physical bank address PBA<0:2> may be translated into the logical bank address LBA 2:4>.

A translation between the physical address and the logical address in FIG. 2 is only an example. The number of bits and position of an address in a translation from the physical row address to the logical bank address may be changed. In some embodiments, some of the physical column address may be translated into the logical bank address.

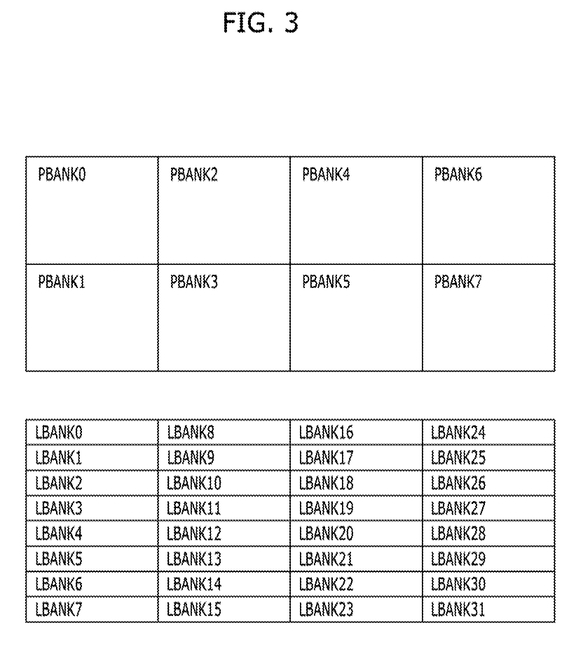

FIG. 3 illustrates a corresponding relation between physical banks and logical banks.

Accordingly, the physical banks PBANK0˜PBANK7 and the logical banks LBANK0˜LBANK31 shown in the same positions correspond to one another. As illustrated for example one physical bank may correspond to 4 logical banks. For example, the physical bank0 PBANK0 may correspond to the logical bank0 LBANK0 to the logical bank3 LBANK3, and the physical bank6 PBANK6 may correspond to the logical bank24 LBANK24 to the logical bank27 LBANK27.

If each of the physical banks PBANK0˜PBANK7 includes 4096 physical rows including a physical row0 to a physical row4095, each of the logical banks LBANK0 LBANK31 may include 1024 logical rows including a logical row0 to a logical row1023. The physical row0 to physical row1023 of the physical bank0 PBANK0 may correspond to the logical row0 to logical row1023 of the logical bank0 LBANK0. The physical row1024 to physical row2047 of the physical bank0 PBANK0 may correspond to the logical row0 to logical row1023 of the logical bank1 LBANK1. The physical row2048 to physical row3071 of the physical bank0 PBANK0 may correspond to the logical row0 to logical row1023 of the logical bank2 LBANK2. The physical row3072 to physical row4095 of the physical bank0 PBANK0 may correspond to the logical row0 to the logical row1023 of the logical bank3 LBANK3. Likewise, the physical rows of the physical bank1 PBANK1 to the physical bank7 PBANK7 may correspond to the logical rows of the logical bank4 LBANK4 to the logical bank31 LBANK31.

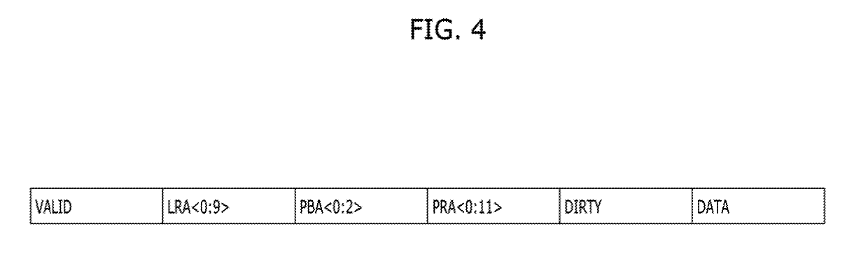

FIG. 4 is a diagram illustrating an example of information stored in each of the row buffers ROW_BUF0˜ROW_BUF31 of FIG. 1, according to an embodiment of the present invention.

According to the embodiment of FIG. 4 each of the row buffers ROW_BUF0˜ROW_BUF31 may store validity information VALID regarding validity of each row buffer, logical row address LRA<0:9>, physical bank address PBA<0:2>, physical row address PRA<0:11>, dirty/clean information DIRTY, and cached data DATA.

The validity information VALID for each row buffer may be indicative of whether the corresponding row buffer is being used or not. If the validity information VALID is “0”, it may mean that a corresponding row buffer is empty. If the validity information VALID is “1”, it may mean that a corresponding row buffer is being used.

The logical row address LRA<0:9> may mean a logical row address corresponding to data cached in a corresponding row buffer.

The physical bank address PBA<0:2> may mean a physical bank address corresponding to data cached in a corresponding row buffer.

The physical row address<PRA<0:11> may mean a physical row address corresponding to data cached in a corresponding row buffer.

The dirty/clean information. DIRTY may be indicative of whether data stored in a corresponding row buffer and data stored in the memory device 110 are the same or not. If the dirty/clean information DIRTY is “0”, it may mean that data stored in a corresponding row buffer and data stored in the memory device 110 are the same (i.e., clean). If the dirty/clean information DIRTY is “1”, it may mean that data stored in a corresponding row buffer and data stored in the memory device 110 are different (i.e., dirty).

The cached data DATA may mean data cached in a corresponding row buffer. The entire data of one row in the memory device 110 may be cached in a row buffer.

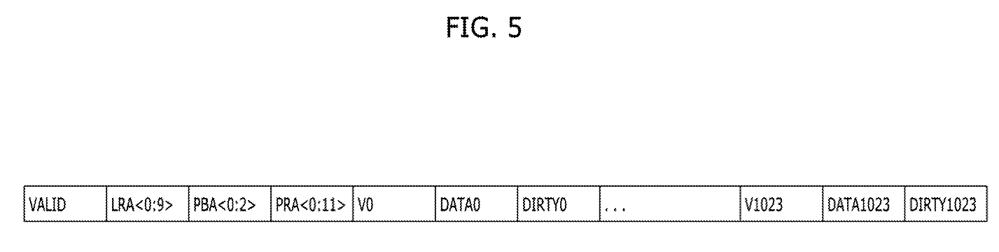

FIG. 5 illustrates another example of information stored in each of the row buffers ROW_BUF0˜ROW_BUF31 of FIG. 1, according to an embodiment of the present invention.

According to FIG. 5, like the information in FIG. 4, each of the row buffers ROW_BUF0˜ROW_BUF31 may store validity information VALID regarding validity of each row buffer, logical row address LRA<0:9>, physical bank address PBA<0:2>, and physical row address PRA<0:11>.

Further, each of the row buffers ROW_BUF0˜ROW_BUF31 may store data validity information V0˜V1023, dirty/clean information DIRTY0˜DIRTY1023 and cached data DATA0˜DATA1023 in a divided structure. Cached data divided into several portions DATA0˜DATA1023 may be stored in each of the row buffers ROW_BUF0˜ROW_BUF31. Pieces of data validity information V0˜V1023 for the respective divided data DATA0˜DATA1023 and pieces of dirty/clean information DIRTY0˜DIRTY1023 for the respective divided data DATA0˜DATA1023 may be stored in each of the row buffers ROW_BUF0˜ROW_BUF31.

The data of one row in the memory device 110 may be divided into 1024 portions and accessed because it may be addressed by a column address of 10 bits. Likewise data cached in the row buffers ROW_BUF0˜ROW_BUF31 may also be divided and stored in 1024 portions DATA0˜DATA1023. Each of the 1024 portions DATA0˜DATA1023 of the cached data may have multiple bits.

Each of the pieces of data validity information V0˜V1023 may be indicative of the validity of each of the 1024 portions DATA0˜DATA1023 of the cached data. Each of the pieces of dirty/clean information DIRTY0˜DIRTY1023 may be indicative of whether each of the 1024 portions DATA0˜DATA1023 of the cached data is dirty or clean.

It is hereinafter assumed that pieces of information, such as those of FIG. 5, are stored in each of the row buffers ROW_BUF0˜ROW_BUF31.

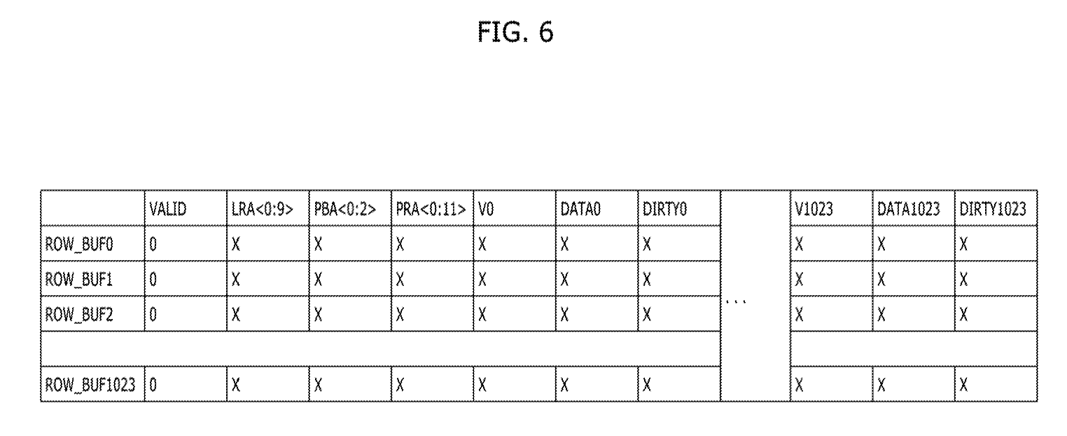

FIGS. 6 to 10 are diagrams illustrating how information stored in the row buffers ROW_BUF0˜ROW_BUF31 of FIG. 1 may be changed when a read operation and a write operation are performed in a memory system 100, according to an embodiment of the present invention.

From FIG. 6, it may be seen that the row buffers ROW_BUF0˜ROW_BUF31 are empty in their initial state. Since all of the row buffers ROW_BUF0˜ROW_BUF31 are empty, the validity information VALID of all of the row buffers ROW_BUF0˜ROW_BUF31 may have a value of “0.”

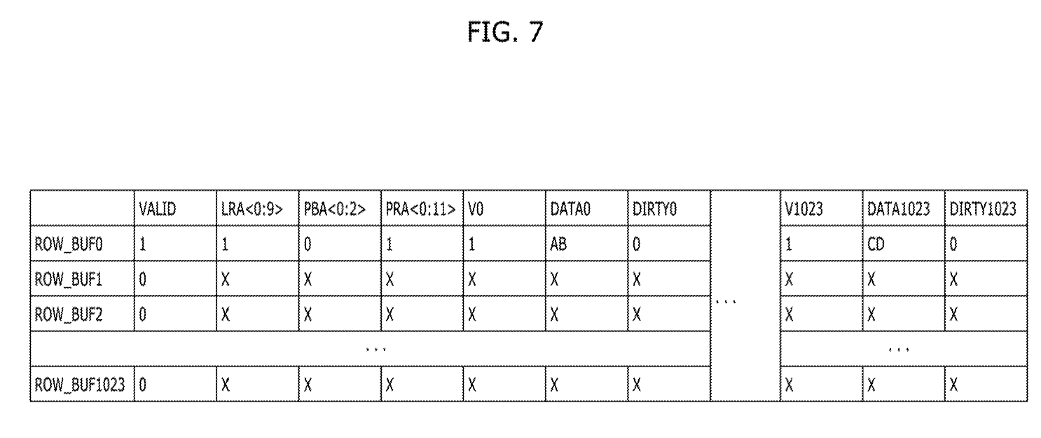

FIG. 7 is a diagram showing the state of the row buffers ROW_BUF0˜ROW_BUF31 after the host HOST has requested a read operation for the logical row1 of the logical bank0 LBANK0 after the state of FIG. 6. Since the row buffer ROW_BUF0 corresponding to the logical bank0 LBANK0 is empty, the row buffer ROW_BUF0 may be immediately updated. The validity information VALID of the row buffer ROW_BUF0 may be updated with “1”, and the logical row address LRA<0:9> may be updated with “1” (indicative of a decimal number). Since the logical row1 of the logical bank0 LBANK0 corresponds to the physical row1 of the physical bank0 PBANK0, the physical bank address PBA<0:2> of the row buffer ROW_BUF0 may be updated with “0” (indicative of a decimal number) and the physical row address PRA<0:11> may be updated with “1” (indicative of a decimal number). Furthermore, data may be read from the physical row1 of the physical bank0 PBANK0 of the memory device 110, and data DATA0˜DATA1023 cached in the row buffer ROW_BUF0 may be updated with the read data. In this case, the entire data of the physical row1 of the physical bank0 PBANK0 has been illustrated as being read, and the row buffer ROW_BUF0 has been illustrated as being updated with the read data. In some embodiments, only the data of a required portion, that is, only the data of columns requested by the host HOST, may be updated. Since all of the cached data DATA0˜DATA1023 is valid and clean, the pieces of data validity information V0˜V1023 may have a value of “1” and the pieces of dirty/clean information DIRTY0˜DIRTY1023 may have a value of “0.” Furthermore, data requested by the host HOST, that is, the data of columns that belong to the logical row1 of the logical bank0 LBANK0 and that have been requested by the host HOST, may be transmitted to the host HOST.

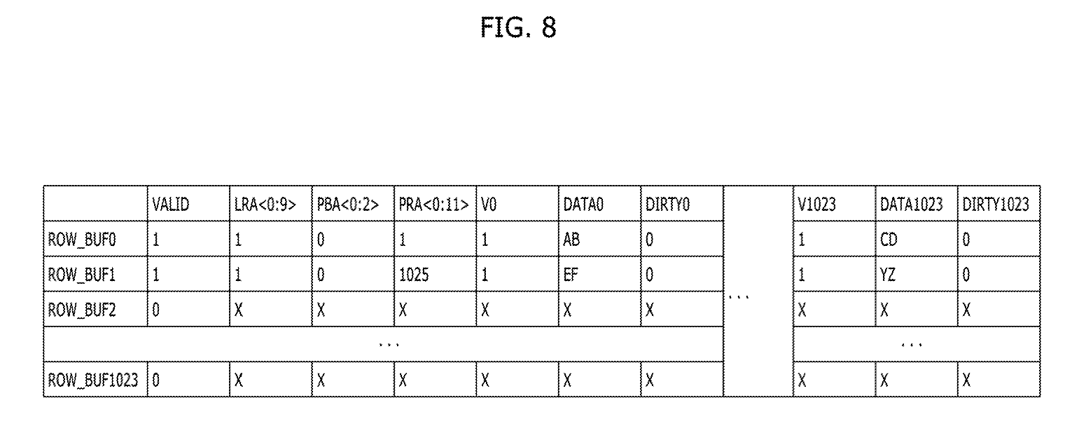

FIG. 8 is a diagram showing the state of the row buffers ROW_BUF0˜ROW_BUF31 after the host HOST has requested a read operation for the logical row1 of the logical bank1 LBANK1 after the state of FIG. 7. Since the row buffer ROW_BUF1 corresponding to the logical bank1 LBANK1 is empty, the row buffer ROW_BUF1 may be immediately updated. The validity information VALID of the row buffer ROW_BUF1 may be updated with “1”, and the logical row address LRA<0:9> may be updated with “1” (indicative of a decimal number). Since the logical row1 of the logical bank1 LBANK1 corresponds to the physical row1025 of the physical bank0 PBANK0, the physical bank address PBA<0:2> of the row buffer ROW_BUF1 may be updated with “0” (indicative of a decimal number) and the physical row address PRA<0:11> may be updated with “1025” (indicative of a decimal number). Furthermore, data may be read from the physical row 1025 of the physical bank0 PBANK0 of the memory device 110, and data DATA0˜DATA1023 cached in the row buffer ROW_BUF1 may be updated with the read data. In this case, the entire data of the physical row1025 of the physical bank0 PBANK0 has been illustrated as being read, and the row buffer ROW_BUF1 has been illustrated as being updated with the read data. However, in some embodiments only the data of a required portion, that is, only the data of columns requested by the host HOST, may be updated. Since all of the cached data DATA0˜DATA1023 is valid and clean, the pieces of data validity information V0˜V1023 may have a value of “1” and the pieces of dirty/clean information DIRTY0˜DIRTY1023 may have a value of “0.” Furthermore, data requested by the host HOST, that is, the data of columns that belong to the logical row1, of the logical bank1 LBANK0 and that have been requested by the host HOST, may be transmitted to the host HOST.

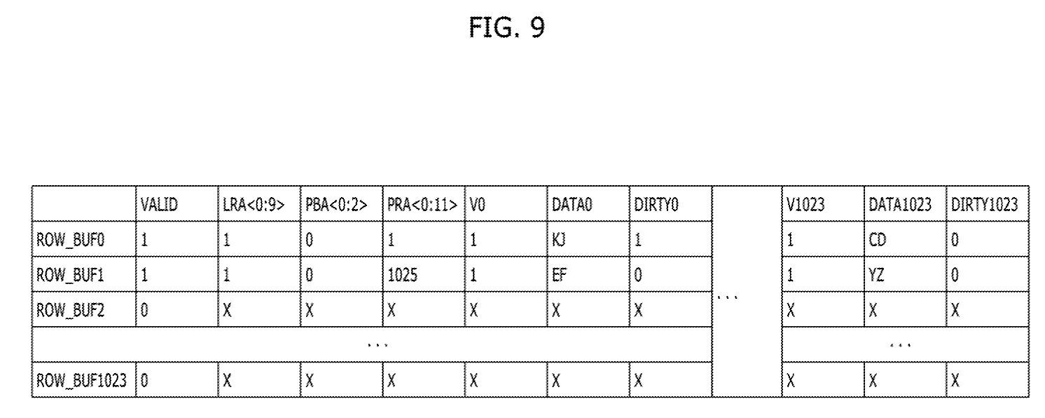

FIG. 9 is a diagram showing the state of the row buffers ROW_BUF0˜ROW_BUF31 after the host HOST has requested a write operation for the logical row1 of the logical bank0 LBANK0 after the state of FIG. 8. The row buffer ROW_BUF0 may be directly updated with write data because the logical row1 has been cached in the row buffer ROW_BUF0 corresponding to the logical bank0 LBANK0. A column portion (illustrated as being the portion DATA0) that belongs to the logical row1 of the logical bank0 LBANK0 and for which the write operation has been requested by the host HOST may be updated with write data KJ. Furthermore, the dirty/clean information DIRTY0 may be updated with “1” because only the row buffer ROW_BUF0 has been updated with the write data KJ and the memory device 110 has not been updated with the write data KJ, that is, because the data KJ stored in the row buffer ROW_BUF0 and data (i.e., AB as a previous value) stored in the memory device 110 are different.

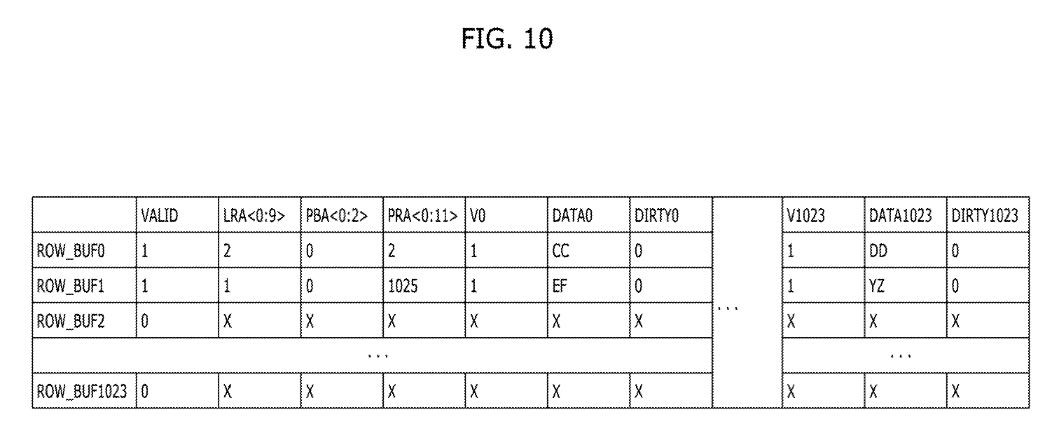

FIG. 10 is a diagram showing the state of the row buffers ROW_BUF0˜ROW_BUF31 after the host HOST has requested a read operation for the logical row 2 of the logical bank0 LBANK0 after the state of FIG. 9. Since the data of the logical row1 has already been cached in the row buffer ROW_BUF0 corresponding to the logical bank0 LBANK0, the data stored in the row buffer ROW_BUF0 needs to be removed in order to cache the data of the logical row 2 in the row buffer ROW_BUF0. An operation for removing the data stored in the row buffer ROW_BUF0 may be performed by moving the portion (KJ in FIG. 9), that is, the data cached in the rove buffer ROW_BUF0, to the memory device 110. After the row buffer ROW_BUF0 becomes empty, the logical row address LRA<0:9> of the row buffer ROW_BUF0 may be updated with “2”, the physical bank address PBA<0:2> thereof may be updated with “0”, the physical row address PRA<0:11> may be updated with “2”, and data read from the physical row2 of the physical bank0 PBANK0 of the memory device 110 may be cached in the row buffer ROW_BUF0, as shown in FIG. 10. Since the data DATA0˜DATA1023 cached in the row buffer ROW_BUF0 has been newly cached from the memory device 110, all of the pieces of data validity information V0˜V1023 may have a value of “1” and all of the pieces of dirty/clean information DIRTY0˜DIRTY1023 may have a value of “0.” Furthermore, data requested by the host HOST, that is, the data of columns that belong to the logical row 2 of the logical bank0 LBANK0 and that have been requested by the host HOST, may be transmitted to the host HOST.

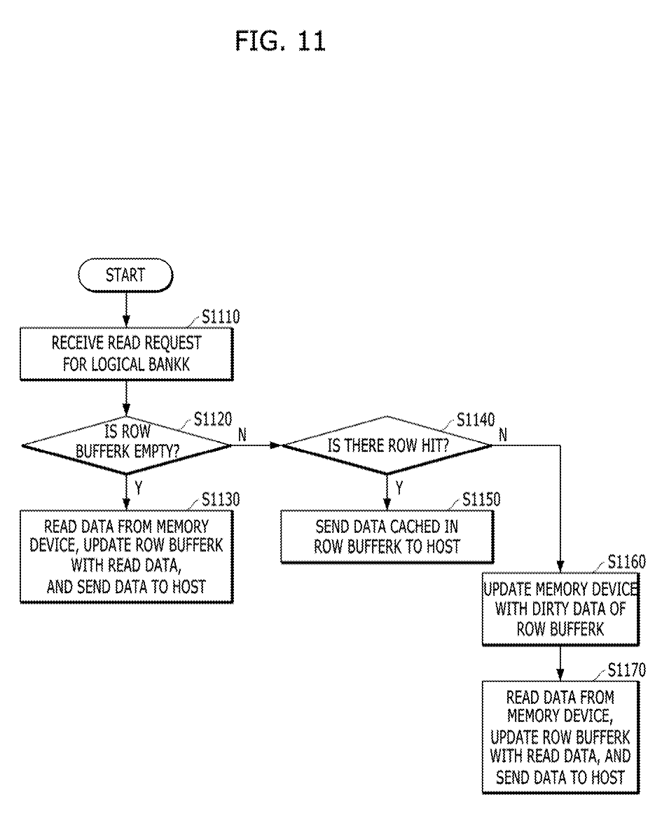

FIG. 11 is a flowchart of a read operation of a memory system, according to an embodiment of the present invention. For example, the read operation of FIG. 11 may be performed by the memory controller 120 of the memory system 100 in FIG. 1.

According to the embodiment of FIG. 11, first at step S1110, the memory system 100 may receive a read request for a logical bank LBANKK. For example, the memory controller 120 of the memory system 100 may receive the read request for a specific logical row of a logical bank LBANKK (K is an integer of 1 or more to 2 or less) from the host HOST.

Furthermore, at step S1120, the memory controller 120 checks whether a row bufferK ROW_BUFK corresponding to the logical bankK LBANKK is empty.

At step S1130, if, as a result of the check of step S1120, the row bufferK ROW_BUFK is determined to be empty (V at step S1120), data is read from the memory device 110, the row bufferK ROW_BUFK is updated with the read data, and data requested by the host HOST is sent to the host. The operation of step S1130 has been described in detail in connection with FIG. 7 and the related description.

If, as a result of the check, the row bufferK ROW_BUFK is determined to be not empty (N at step S1120), the memory controller 120 checks whether there is a row hit at step S1140. In this case, a row hit means that the logical row of the logical bankK LBANKK for which the host HOST has requested a read operation is identical to a logical row cached in the row bufferK ROW_BUFK.

At step S1150, if, as a result of the check of step S1140, a row hit is determined to be present (Y at step S1140), the memory controller 120 sends data which are cached in the row bufferK ROW_BUFK to the host HOST because the data requested by the host HOST has already been cached in the row bufferK ROW_BUFK.

At step S1160 if, as a result of the check of step S1140, a row hit is not present (N at step S1140), the controller 120 updates the memory device 110 with dirty data stored in the row bufferK ROW_BUFK. At step S1170, data is read from the memory device 110, the row bufferK ROW_BUFK is updated with the read data, and data requested by the host HOST is sent to the host HOST. When the row bufferK ROW_BUFK is updated with the data read from the memory device 110, the entire data of one row may be updated or only some of the data of one row may be updated. An operation in this case has been described in detail in connection with FIG. 10 and the related description.

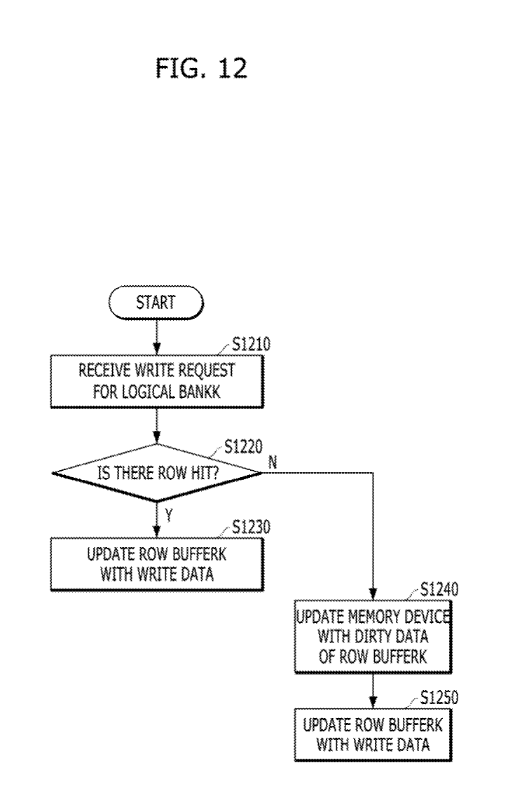

FIG. 12 is a flowchart of a write operation of a memory system, according to an embodiment of the present invention. For example, the write operation of FIG. 12 may be performed by the memory controller 120 of the memory system 100 in FIG. 1.

According to the embodiment of FIG. 12, first, the memory controller 120 may receive a write request for a specific logical row of a logical bankK LBANKK from the host HOST at step S1210.

Then at step S1220, the memory controller 120 checks whether there is a row hit, for example, between a row bufferK ROW_BUFK and the write request received at step S1210. In some embodiments, the case that there is no row hit may include a case where a logical row cached in the row bufferK ROW_BUFK is not identical to a logical row for which a write operation has been requested at step S1210 and a case where the row bufferK ROW_BUFK is empty.

At step S1230, if, as a result of the check of step S1220, the row hit is determined to be present (Y at step S1220), the row bufferK ROW_BUFK is directly updated with write data. An operation in this case has been described in detail in connection with FIG. 9 and the related description.

At step S1240, If, as a result of the check, the row hit is not present (N at step S1220), the memory device 110 is updated with the dirty data of the row bufferK ROW_BUFK. The execution of step S1240 may be omitted because there is no update data for the memory device 110 if the dirty data is not present. Thereafter, a logical row cached in the row bufferK ROW_BUFK is changed to a logical row requested at step S1210, and the row bufferK ROW_BUFK is updated with write data at step S1250.

According to the embodiments of the present invention, performance of the memory system can be improved without increasing the cost for the memory system.

Although various embodiments have been described for illustrative purposes, it will be apparent to those skilled, in the art that various changes and modifications may be made without departing from the spirit and/or scope of the invention as defined in the following claims.

What is claimed is:

1. A memory system, comprising:
a memory device including N physical banks, and a memory controller suitable for communicating with a host and with the memory device, the memory controller comprising M row buffers and an address translator, the M row buffers being suitable for caching data of corresponding M logical banks, the address translator being suitable for performing an address translation between a logical address used for communication with the host and a physical addresses used for communication with the memory device;
wherein the memory controller communicates with the host using the M logical banks, N is an integer equal to or greater than 1, and M is an integer greater than N.

2. The memory system of claim 1, wherein:
the logical address comprises a logical bank address, a logical row address, and a logical column address, and
the physical address comprises a physical bank address, a physical row address, and a physical column address.

3. The memory system of claim 2, wherein the address translator translates some bits of the logical bank address into the physical bank address, translates remaining bits of the logical bank address and the logical row address into the physical row address, and translates the logical column address into the physical column address.

4. The memory system of claim 2, wherein each of the M row buffers stores:
cached data;
validity information regarding validity of the row buffer;
a logical row address of the cached data;
a physical bank address of the cached data;
a physical row address of the cached data; and
dirty/clean information indicating dirty or clean for the cached data.

5. The memory system of claim 2, wherein each of the M row buffers stores:
cached data divided into two or more portions;
validity information regarding validity of the row buffer;
a logical row address of the cached data;
a physical bank address of the cached data;
a physical row address of the cached data;
data validity information regarding validity for each of the two or more portions of the cached data; and
dirty/clean information indicating dirty or clean for each of the two or more portions of the cached data.

6. The memory system of claim 2, wherein:
if data of a logical bank address and logical row address to be read by the host has been cached in a row buffer of a corresponding logical bank of the M row buffers, the memory controller reads the data from the row buffer of the corresponding logical bank and sends the read data to the host.

7. The memory system of claim 2, wherein:
if data of a logical bank address and logical row address to be read by the host has not been cached in a row buffer of a corresponding logical bank of the M row buffers, the memory controller reads data from the memory device using a physical bank address and physical row address converted from the logical bank address and logical row address to be read by the host and transfers the read data to the host.

8. The memory system of claim 2, wherein when the host instructs a write operation, the memory controller accesses a row buffer among the M row buffers and updates the accessed row buffer with write data, the accessed row buffer being a row buffer of a logical bank for which the write operation has been instructed.

9. The memory system of claim 8, wherein the memory device is updated with the write data with which the row buffer of the logical bank for which the write operation has been instructed has been updated if a row cached in the row buffer of the logical bank for which the write operation has been instructed is changed.

10. The memory system of claim 1, wherein the memory controller further comprises:
a host interface suitable for communication with the host;
a scheduler suitable for determining a sequence of operations of the memory device;
a command generator suitable for generating commands to be applied to the memory device; and
a memory interface suitable for communication with the memory device.

11. The memory system of claim 1, wherein the host activates one row at a time for each logical bank.

12. An operating method of a memory controller comprising:
receiving a read request for a specific logical row of a K-th logical bank of M logical banks from a host;
determining whether a row buffer of the K-th logical bank is empty;
if it is determined that the row buffer of the K-th logical bank is empty, reading data from a certain physical row of a certain physical bank among N physical banks included in a memory device and transferring the read data to the host, wherein the certain physical bank is corresponding to the K-th logical bank, and the certain physical row is corresponding to the specific logical row; and
updating the row buffer of the K-th logical bank with the read data from the memory device,
wherein the N is an integer of 1 or more, the M is an integer greater than N, and the K is an integer of 1 or more to M or less.

13. The operating method of claim 12, further comprising:
if it is determined that that the row buffer of the K-th logical bank is not empty, determining whether there is a row hit for the K-th row buffer,

14. The operating method of claim 13, further comprising:
if it is determined that there is the row hit for the K-th row buffer, transferring data stored in the K-th row buffer to the host.

15. The operating method of claim 14, further comprising:
if it is determined that there is no the row hit for the K-th row buffer, updating a region of the memory device corresponding to a physical bank address and a physical row address with dirty data stored in the K-th row buffer.

16. The operating method of claim 15, further comprising:
reading the data from the physical row corresponding to the specific logical row of the physical bank which belongs to the N physical banks of the memory device and which corresponds to the K-th logical bank and transferring the read data to the host.

17. The operating method of claim 16, further comprising updating the row buffer of the K-th logical bank with the data read from the memory device.

18. An operating method of a memory controller, comprising:
receiving a write request for a specific logical row of a K-th logical bank of M logical banks from a host;
determining whether there is a row hit for a row buffer of the K-th logical bank;
if it is determined that there is the row hit, updating the row buffer of the K-th logical bank with write data;
if it is determined that there is no the row hit, updating a physical row, corresponding to the specific logical row of a physical bank which belongs to N physical banks of a memory device and which corresponds to the K-th logical bank, with dirty data of the row buffer of the K-th logical bank; and
updating the row buffer of the K-th logical bank with the write data,
wherein the N is an integer of 1 or more, the M is an integer greater than N, and the K is an integer of 1 or more to M or less.
